(19) United States
(12) Patent Application Publication
(10) Pub. No.: US 2007/0279682 A1
(43) Pub. Date: Dec. 6, 2007

(54) Data communications terminal and method of printing data by using a data communications terminal

(75) Inventor: Ryo Ogata, Ome-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/716,636

(22) Filed: Mar. 12, 2007

(30) Foreign Application Priority Data
May 31, 2006 (JP) 2006-152122

(51) Int. Cl. G06F 3/12

(52) U.S. Cl. 358/1.15

(57) ABSTRACT

According to one embodiment, a data communications terminal comprising an acquisition unit, a decision unit, and a control unit. The acquisition unit acquires data from a data source via a network. The decision unit determines whether a printer connected to the terminal is permitted to acquire the data from the data source and print the data. The control unit transmits to the printer the data acquired by the acquisition means when the decision unit determines that the printer is not permitted to acquire the data from the data source and print the data.

### CROSS-REFERENCE TO RELATED APPLICATIONS

This application is based upon and claims the benefit of priority from Japanese Patent Application No. 2006-152122, filed May 31, 2006, the entire contents of which are incorporated herein by reference.

### BACKGROUND

1. Field

One embodiment of the invention relates to a data communications terminal that can determines whether a printer is connected to the Internet.

2. Description of the Related Art

As is known, the digitization of television broadcasting has been promoted in recent years. In Japan, for example, not only broadcasting satellite (BS) digital broadcasting and 110°—communications satellite (CS) digital broadcasting, but also terrestrial digital broadcasting has been started.

Digital television set that can receive digital data broadcast in these broadcasting systems can be connected to the Internet to acquire data and can therefore display the data thus acquired. Further, digital television sets can be connected to various external apparatuses, too, via UBS or LAN. In view of this, any digital television set should be easy to handle and be fully fit to practical use.

Jpn. Pat. Appln. KOKAI Publication No. 2004-114651 discloses a printer. The printer is connected a WAN (Wide Area Network) such as the Internet and a LAN (Local Area Network). It can therefore perform two-way communication. When the printer receives a request for printing from any LAN terminal, it acquires content data from a server on the WAN in accordance with predetermined discrimination conditions, so that it may print the content data.

Jpn. Pat. Appln. KOKAI Publication No. 10-214163 discloses a printer, too. This printer is connected to a network such as the Internet. It has an access-management data registering means that designates a data resource on the network and sets an access time. When the access time represented by the data registered in the registering means comes, the printer is connected to the data source designated. The printer receives data from the data source of data, and prints the data. The printers disclosed in Publication Nos. 2004-114651 and 10-214163 accesses a data source and print the data acquired from the source. Neither Publication No. 2004-114651 nor Publication No. 10-214163 describes what the printer does if it cannot access the data source.

The invention has been made in view of the foregoing. An object of the invention is to provide a data communications terminal that can authenticate content data and make a printer print the content data authenticated, and to a method of printing content data by using such a data communications terminal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a data communications terminal according to a first embodiment of the invention, and the configurations of the apparatuses peripheral to the terminal;

FIG. 2 is a block diagram showing the internal configuration of the data communications terminal according to the first embodiment of the invention;

FIG. 3 is a block diagram explaining the procedure of printing the data displayed on the data communications terminal according to the first embodiment of the invention;

FIG. 4 is a flowchart explaining a procedure of printing the data displayed on the data communications terminal according to the first embodiment of the invention;

FIG. 5 is a flowchart explaining another procedure of printing the data displayed on the data communications terminal according to a second embodiment of the invention;

FIG. 6 is a diagram the contents of an HTML request used to acquire the data displayed on the data communications terminal according to the second embodiment of the invention; and

FIG. 7 is a flowchart explaining still another procedure of printing the data displayed on the data communications terminal according to a third embodiment of the invention.

### DETAILED DESCRIPTION

Various embodiments according to the invention will be described hereinafter with reference to the accompanying drawings. In general, according to one embodiment of the invention, a data communications terminal comprises acquisition means for acquiring data from a data source via a network, a decision means for determining whether a printer connected to the data communications terminal is permitted to acquire the data from the data source and print the data and control means for transmitting to the printer the data acquired by the acquisition means when the decision means determines that the printer is not permitted to acquire the data from the data source and print the data.

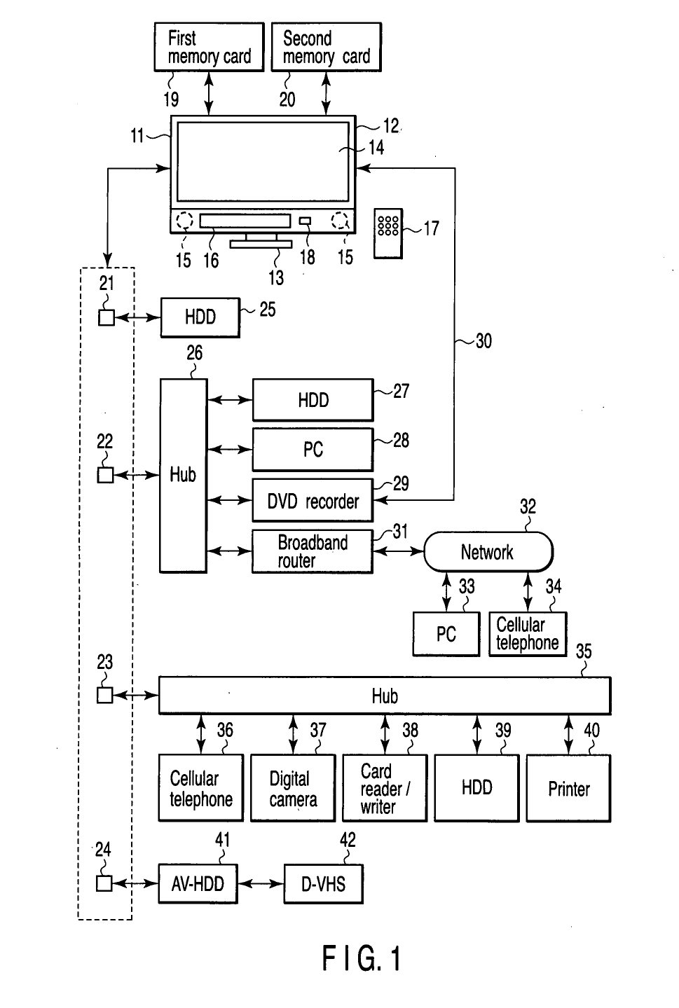

An embodiment of this invention will be described in detail, with reference to the accompanying drawings. FIG. 1 schematically shows the outer appearance of a data communications terminal 11 according to the embodiment, and a network system in which this data communications terminal 11 plays a main role.

The data communications terminal 11 (e.g., a digital television set) comprises mainly a thin cabinet 12 and a support base 13 supports the cabinet 12 in a standing position. On the cabinet 12, a display 14, speakers 15, a control unit 16, and a light-receiving unit 18 are provided. The display 14 comprises a flat panel such as a liquid crystal display panel. The light-receiving unit 18 receives operation data transmitted from a remote controller 17.

The data communications terminal 11 holds a first memory card 19 that removable. The first memory card 19 is, for example, a secure digital (SD) memory card, a multimedia card (MMC) or the like. Data, such as programs and photographs, can be recorded in, and reproduced from, the first memory card 19.

The data communications terminal 11 hold a second memory card 20, too, which is removable. The second memory card 20 is, for example, an integrated circuit (IC) card and incorporates a semiconductor memory in which contract data etc. has been recorded. Data can be recorded in, and reproduced from, the second memory card 20.

The data communications terminal 11 comprises a first local-area-network (LAN) terminal 21, a second LAN terminal 22, a universal serial bus (USB) terminal 23, and an IEEE1394 terminal 24.

The first LAN terminal 21 is used as a port dedicated to a hard disk drive (HDD) connected to the LAN, i.e., a network attached storage (NAS). The first LAN terminal 21 is used to record and reproduce data in and from the HDD25 connected to LAN, through the Ethernet (registered trademark).

Thus, the first LAN terminal 21 is a port dedicated to the HDD connected to the LAN. The data about High-Vision programs can therefore be reliably recorded, not influenced by other network environments, the network operating conditions, or the like.

The second LAN terminal 22 is a port corresponding to an ordinary LAN that uses the Ethernet (registered trademark). The second LAN terminal 22 is connected by, for example, a hub 26 to apparatuses such as a LAN-dedicated HDD27, a personal computer (PC) 28 and a DVD recorder 29 incorporating an HDD. The second LAN terminal 22 is used to transmit data to and from these apparatuses.

For the DVD recorder 29, the digital data transmitted via the second LAN terminal 22 is nothing but control data. For this reason, an analog transmission line 30 must be used only for transmitting and receiving analog video data and analog audio data to and from the data communications terminals 11.

Further, the second LAN terminal 22 is connected to a network 32, such as the Internet, via a broadband router 31 that is connected to the hub 26. The second LAN terminal 22 is used to perform data transmission with the PC 33, a cellular telephone 34 or the like through the network 32.

The USB terminal 23 is one that is used as an ordinary USB port. The USB terminal 23 is connected to a cellular telephone 36, a digital camera 37, a card reader/writer 38 for the memory card, an HDD39, a printer 40 and the like via, for example, a hub 35. The USB terminal 23 is used to perform data transmission with these USB apparatuses. The printer 40 is connected to the data communications terminal 11, by a LAN (not shown).

An AV-HDD 41 and a digital-video home system (D-VHS) 42 are connected in series to the IEEE1394 terminal 24. A digital terrestrial tuner (not shown) and the like are connected to the AV-HDD 41. The IEEE1394 terminal 24 is used to perform data transmission with these apparatuses.

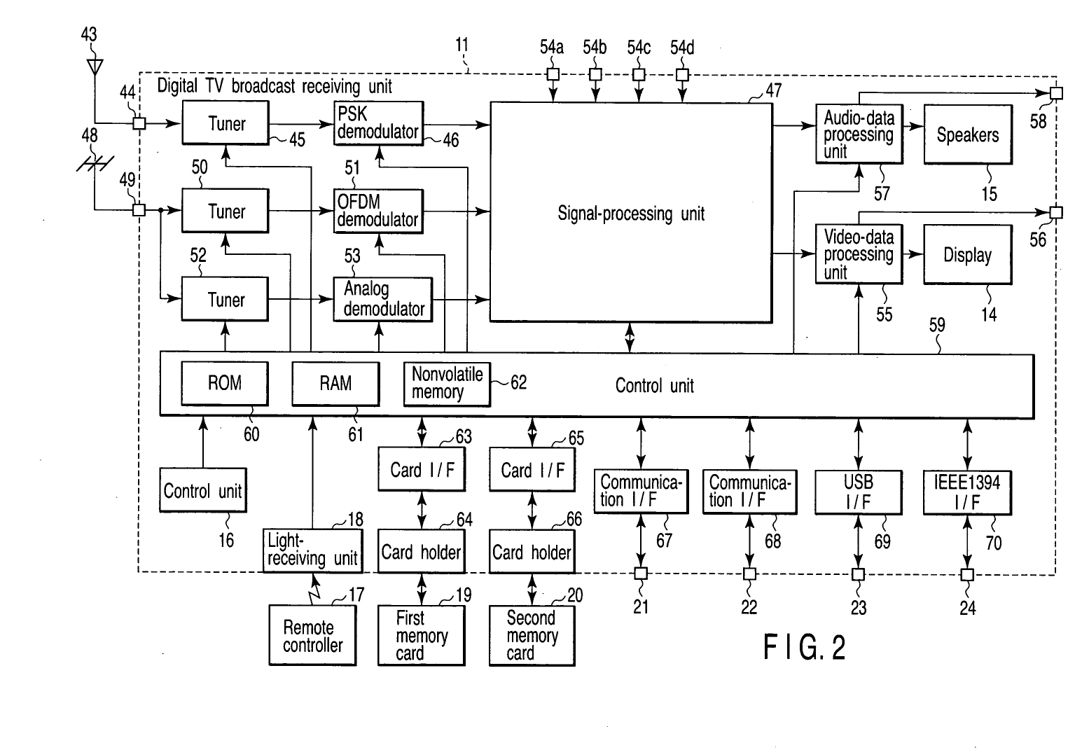

FIG. 2 shows the main signal-processing systems provided in the data communications terminal 11 described above. An antenna 43 for digital BS/CS broadcasting reception receives a digital satellite TV-broadcast signal. This signal is supplied to a tuner 45 for digital satellite broadcasting through an input terminal 44. The broadcast signal of a desired channel is thereby turned in.

The broadcast signal turned in by the tuner 45 is supplied to PSK (phase shift keying) demodulator 46. The signal is demodulated into a digital video signal and a digital audio signal. The digital audio and audio signals are output to a signal-processing unit 47.

An antenna 48 for terrestrial broadcasting reception receives a digital terrestrial TV-broadcast signal. The received digital terrestrial TV-broadcast signal is supplied to a tuner 50 for digital terrestrial broadcasting via an input terminal 49. Tuner 50 tunes in the broadcast signal of the desired channel.

The broadcast signal tuned in by the tuner 50 is supplied to an orthogonal frequency-division multiplexing (OFDM) demodulator 51. The (OFDM) demodulator 51 demodulates the broadcast signal into a digital audio signal and a digital audio signal. The digital audio and audio signals are output to the signal-processing unit 47.

The antenna 48 for terrestrial broadcasting reception receives a terrestrial analog TV-broadcast signal. This signal is supplied via an input terminal 49 to a tuner 52 for ground analog broadcasting. A broadcast signal of a desired channel is thereby tunes in. The tuner 52 tunes in the broadcasting signal, which is supplied to an analog demodulator 53. The analog demodulator 53 demodulates the signal to an analog video signal and an analog audio signal. The analog video and audio signals are output to the signal processing part 47.

A plurality of input terminals, or four input terminals 54a, 54b, 54c, and 54d, are connected to the signal-processing unit 47. The input terminals 54a to 54d can receive analog video signals and analog audio signals from outside the data communications terminal

The signal-processing unit 47 performs a selective digital process on digital video and audio signals supplied from the PSK demodulator 46 and the OFDM demodulator 51.

The signal-processing unit 47 selectively converts the analog video and audio signals supplied from the analog demodulator 53 and the input terminals 54a-54d to digital signals. The signal-processing unit 47 performs specific processes on the digital video and audio signals.

The processes that the signal-processing unit 47 performs include, for example, the MPEG decoding of video signals, MPEG noise reduction, i.e., reduction of mosquito noise generated during the MPEG decoding, the superimposing of digital graphics data for OSD (hereinafter referred to as OSD signal) on the video signals, the scaling of video signals, and the decoding of audio signals.

The digital video signal output from the signal-processing unit 47 is supplied to a video-data processing unit 55. The image-processing unit 55 converts the digital video signal to an analog video signal of such a format that the display 14 can use to display images. The analog video signal is output to the display 14. The display 14 displays the image represented by the analog video signal. An analog video signal is sent outside from an output terminal 56.

The digital audio signal output from signal-processing unit 47 is supplied to an audio-data processing unit 57. The audio-data processing unit 57 converts the input digital audio signal to an analog audio signal of such a format that the speakers 15 can use to generate sound. The analog voice signal is output to the speakers 15. The speakers 15 generate sound from the analog audio signal. The audio-data processing unit 57 supplies the analog audio signal to an output terminal 58. The analog audio signal is sent outside from the output terminal 58.

A control unit 59 controls the operation of the data communications terminal 11, including various types of signal receiving. The control unit 59 incorporates a central processing unit (CPU) and the like. The control section 59 receives operation data from the control unit 16. The control unit 59 receives operation data from the remote controller 17, too, through the light-receiving unit 18. In accordance with the operation data, the control section 59 controls the various units.

The control unit 59 uses a read only memory (ROM) 60, a random access memory (RAM) 61, and a nonvolatile memory 62. The ROM 60 stores mainly the programs that the CPU executes. The RAM 61 provides a working area for the CPU. The nonvolatile memory 62 stores various set data items and various control data items.

The control unit is connected via a card I/F(Interface) 63 to a card holder 64 that can hold first memory card 19. The control unit 59 can therefore transmit and receive data to and from the first memory card 19 held in the card holder 64, through the card I/F 63.

The above-mentioned control unit 59 is connected to a card holder 66 that can hold the second memory card 20, through a card I/F 65. The control unit 59 can therefore transmit and receive data to and from the second memory card 20 held in the card holder 66, through the card I/F 65.

The control unit 59 is connected to the first LAN terminal 21 via a communication I/F 67. The control unit can 59 can therefore transmit and receive data to and from the LAN-dedicated HDD 25 connected to the first LAN terminal 21, through the communication I/F 67. The control unit 59 has a dynamic host configuration protocol (DHCP) server function. The control unit 59 allocates an Internet protocol (IP) address to the LAN-dedicated HDD 25 connected to the first LAN terminal 21.

The control unit is connected to the second LAN terminal 22 via a communication I/F68 that is used as means for acquiring data. The control unit 59 can therefore transmit and receive data to and from the apparatuses (see FIG. 1) connected to 2nd LAN terminal 22, through the communication I/F 68.

The control unit is 59 connected to the USB terminal 23 via an USB I/F 69. The control unit 59 can therefore transmit and receive data to and from the apparatuses (see FIG. 1) connected to the USB terminal 23, through the USB I/F 69.

Further, the above-mentioned control unit 59 is connected to the IEEE1394 terminal 24 via an IEEE1394 I/F 70. The control unit can therefore transmit and receive data to and from the apparatuses (see FIG. 1) connected the IEEE1394 terminal 24, through the IEEE1394 I/F 70.

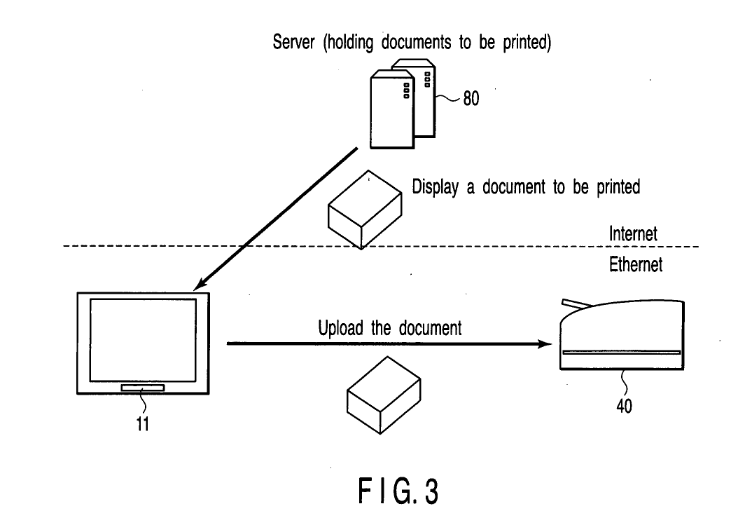

It will be described how the data communications terminal 11 is connected to the network 32, such as the Internet, via the second LAN terminal 22 and the broadband router 31 connected to the hub 26, how the terminal 11 acquires data from a sever 80 (shown in FIG. 3) existing on the network 32 and configured to distribute contents on the network 32, and how the printer 40 prints the page displayed on the data communications terminal 11.

FIG. 3 is a block diagram showing how the terminal 11 displays a print document acquired from the server 80 that distributes contents on the network 32 and how the printer 40 prints the document displayed on the data communications terminal 11.

The data communications terminal 11 and the printer 40 exist on the same LAN. Hence, they can access each other. Both the terminal 11 and the printer 40 have a network address translator (NAT). The NAT of the terminal 11 and the NAT of the printer 40 shares one global address. The terminal 11 and the printer 40 can therefore access the server 80 on the network 32, which distributes content data.

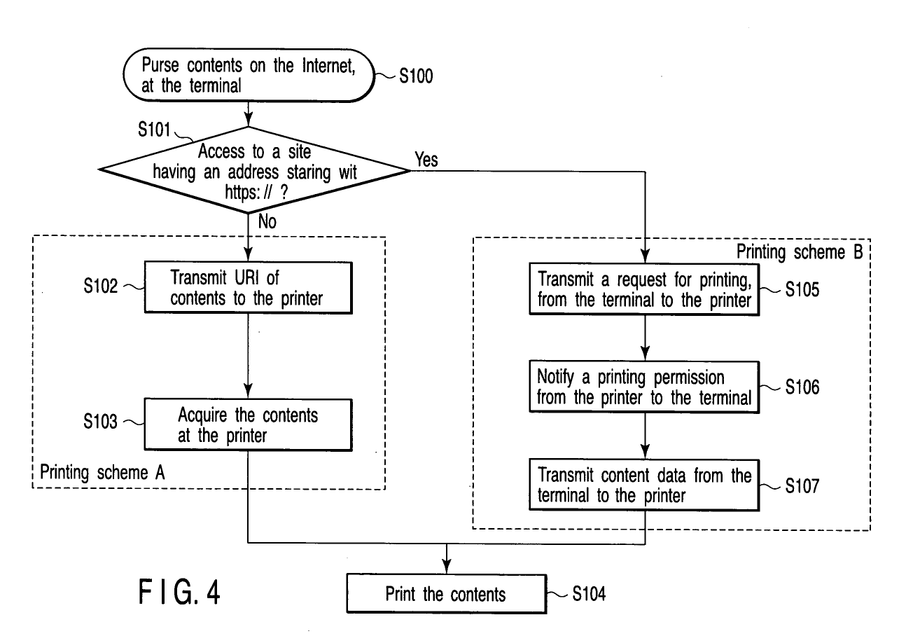

The first embodiment will be described, with reference to FIG. 4. The data communications terminal 11 displays the content data on the network 32 so that the user of the terminal 11 may read the data (Step S100). The control unit 59, which is a decision means provided in the data communications terminal 11, determines whether the content data displayed on the terminal 11 has been acquired from the site whose address starts with https:// (Step S101).

If the address of the site from which the terminal 11 has acquired the content data does not start with https:// (if NO in Step S101), the data communications terminal 11 transmits to the printer 40 via the LAN, the uniform resource identifier (URI) data that represents the site from which the contents data has been acquired (Step S102). The printer 40 acquires the same contents data that the data communications terminal 11 is displaying, from the resource identified by the URI data (Step S103). The operation performed in Steps S102 to S103 is defined as printing scheme A. The printer 40 prints the contents data (Step S104).

If the address of the site from which the terminal 11 has acquired the content data starts with https:// (if YES in Step S101), then server 80 has been authenticated to distribute the content data and the data communications terminal 11 has been authenticated to receive the content data. Since the data communications terminal 11 has been authenticated to receive the content data, the printer 40 cannot be authenticated to receive the same content data from the server 80. Therefore, the terminal 11 downloads the content data to the printer 40. The terminal 11 transmits via the LAN the request for printing of the contents data downloaded to the printer 40 (Step S105). The printer 40 notifies to data communications terminal 11 the permission of printing in response to the request transmitted from the data communications terminal 11 via the LAN (Step S106). On receiving the notification of printing permission from the printer 40, the control unit 59 of the data communications terminal 11 transmits the downloaded contents data to the printer 40 via the LAN (Step S107). The operation performed in Steps S105 to S107 is defined as printing scheme B. The printer 40 prints this contents data (Step S104).

As mentioned above, the data communications terminal 11 needs only to determine whether any address starts with https://. Hence, such an address can be easily discriminated. Thus, the content data can be changed from one for print scheme A to one for printing scheme B, or vice versa.

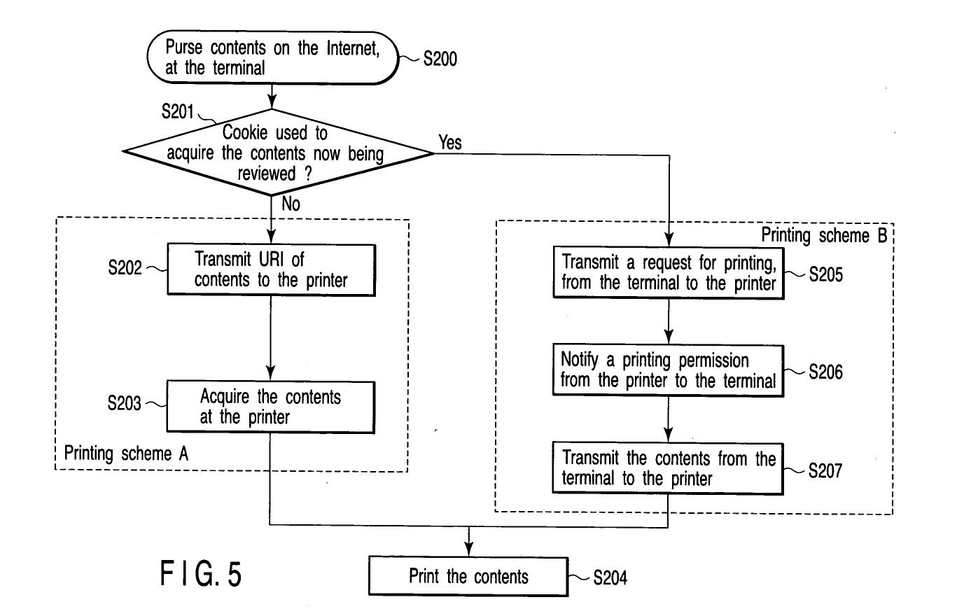

A second embodiment will be described, with reference to FIG. 5. The data communications terminal 11 displays the content data available on network 32 so that the user may peruse the content data (Step S200). The control unit 59 of the terminal 11 determines whether Cookie has been used to acquire the content data displayed on the data communications terminal 11 (Step S201). This decision is made in accordance with, for example, whether the request of acquisition of contents data contains the Cookie data.

If Cookie has not been used to acquire the content data displayed on data communications terminal 11 (if NO in Step S201), the terminal 11 will transmit the URI data representing the site of the content data, to the printer 40 via the LAN (Step S202). The printer 40 acquires from the URI the same content data as the data currently displayed on the data communications terminal 11 (Step S203). The operation performed in Steps S202 to S203 is defined as printing scheme A. The printer 40 prints the content data (Step S204).

Assumed that Cookie has been used to acquire the content data displayed on the data communications terminal 11 (if YES in Step S201). Then, the Cookie data is contained in the request for acquiring the content data. The printer 40 may therefore be unable to acquire the same contents data. Hence, the data communications terminal 11 downloads the content data.

The data communications terminal 11 transmits the request for printing the downloaded content data to the printer 40 via the LAN (Step S205). The printer 40 notifies the permission of printing in response to the request transmitted from the data communications terminal 11, via the LAN to the data communications terminal 11 (Step S206). The control unit 59 of the data communications terminal 11, which has received the notice of printing permission from the printer 40, transmits the downloaded content data to the printer 40 via the LAN (Step S207). The operation performed in Steps S205 to S207 is defined as printing scheme A. The printer 40 prints the contents data (Step S204).

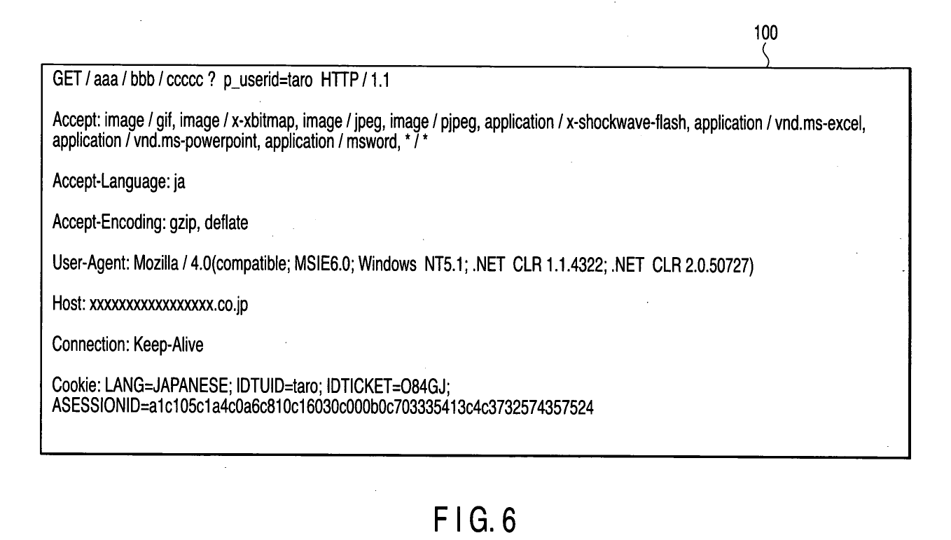

In order to display the contents data to the user, the data communications terminal 11 transmits such a hyper-text-markup language (HTML) request as shown in FIG. 6, to the server 80 that distributes the contents data. The HTTP request transmitted to the server 80 that distributes content data may contain Cookie (100 shown in FIG. 6) to acquire the contents data currently displayed on data communications terminal 11. In this case, the terminal 11 determines in Step S201 that the content data acquired contains the data inherent to the terminal (i.e., data containing Cookie).

The data communications terminal 11 can determine whether the HTTP request transmitted from it to the server 80 contains Cookie, only by discriminating the history of the HTTP request transmitted to the server 80 that distributes the contents data. Therefore, the printing scheme can be switched from scheme A to scheme B, merely in accordance with whether the HTTP request contains Cookie or not.

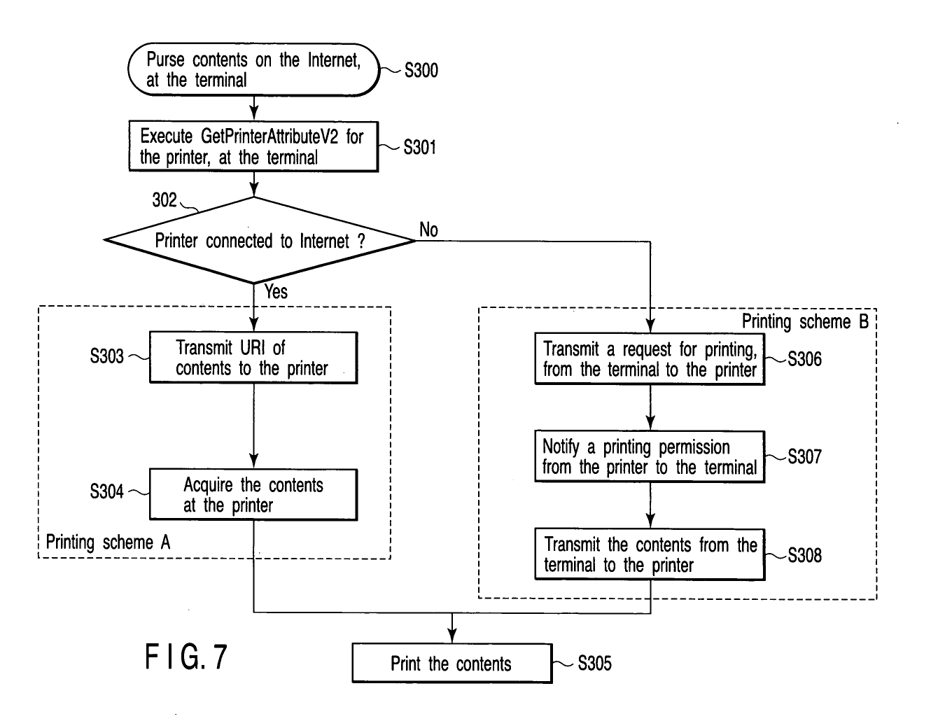

A third embodiment will be described, with reference to FIG. 7. The data communications terminal 11 displays the contents data on network 32 so that the user may peruse it (Step S300). The control unit 59 of the data communications terminal 11 executes command GetPrintAttributesV2 that discriminates the status of the printer 40, e.g., connection state with respect to the network 32, for the printer 40 connected to the terminal 11 via the LAN (Step S301). Executing this command, the control unit 58 of the data communications terminal 11 determines whether the printer 40 is connected to the network 32 because of the value of parameter InternetConnectState obtained by executing the command (S302).

If the data communications terminal 11 determines that the printer 40 is connected to the network 32 (if YES in Step S302), it will transmit a URI data showing the site of the contents data, to the printer 40 via the LAN (S303). The printer 40 acquires from the URI the same contents data as currently displayed on the data communications terminal 11 (S304). The operation of Steps S303 to S304 is defined as printing scheme A. The printer 40 prints this contents data (S305).

If the data communications terminal 11 determines that the printer 40 is not connected to the network 32 (if NO in Step S302), it determines that the printer 40 cannot access to the URI of the content data the terminal 1 has designated. The terminal 11 then downloads this content data.

The data communications terminal 11 transmits a request for printing the downloaded contents data to the printer 40 via LAN (Step S306). The printer 40 notifies printing permission in response to the request for printing, to data communications terminal 11 via the LAN (Step S307). Upon receiving the printing permission from the printer 40, the control unit 59 of the data communications terminal 11 transmits the downloaded content data to the printer 40 via the LAN (Step S308). The operation of Steps S306 to S308 is defined as printing scheme B. The printer 40 prints the contents data (S305).

The data communications terminal 11 may executes the command GetPrintAttributesV2 for the printer 40 periodically connected to it via the LAN, thus determining the connection state of the printer 40 with respect to the network 32. Then, it can be easily determined whether the printer 40 is connected to the network 32. Therefore, the printing scheme can be switched from scheme A to scheme B, merely in accordance with whether the printer 40 is connected to the network 32.

For example, the server 80 that distributes contents is a portal site on the network 32, the data communications terminal 11 is a digital television set, and the printer 40 is a home network printer. The data communications terminal 11 and the printer 40 are connected to the domestic LAN via the router (not shown) that has an NAT function. Assume that the data communications terminal 11 instructs that the printer 40 should print the weather forecast page and a member-dedicated page with a password (e.g., an Internet mail), both stored in the portal site. At this time, the printer 40 print the weather forecast page only if the URI data is transmitted to the printer 40 and the printer 40 access the URI (printing scheme A). The printer 40 does not have the authentication key the browser of the data communications terminal 11 holds, even if the URI data is transmitted to the printer 40. Hence, the member-dedicated page with a password is denied an access to the server 80 that distributes it. In this case, the printer 40 can print this member-dedicated page if the HTML data about the member-dedicated page with a password is transmitted to the printer 40, after the data communications terminal 11 has accessed the server 80 of the portal site (printing scheme B).

Hence, the contents data can be printed, though it cannot be printed only by specifying the address of server 80 that distributes the content data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data communications terminal comprising:
acquisition means for acquiring data from a data source via a network;
a decision means for determining whether a printer connected to the data communications terminal is permitted to acquire the data from the data source and print the data; and
control means for transmitting to the printer the data acquired by the acquisition means when the decision means determines that the printer is not permitted to acquire the data from the data source and print the data.

2. The data communications terminal according to claim 1, wherein the decision means determines that the printer is not permitted to acquire the data from the data source and print the data, when the data source is a site that has an address that starts with https://.

3. The data communications terminal according to claim 1, wherein the decision determines that the printer is not permitted to acquire the data from the data source or print the data, when Cookie is used to acquire the data from the data source.

4. The data communications terminal according to claim 1, wherein the decision means determines that the printer is not permitted to acquire the data from the data source or print the data, when the printer is not connected to the network.

5. The data communications terminal according to claim 4, wherein the decision means confirms, at regular intervals, a connection state that the printer assumes with respect to the network.

6. A printing method using a data communications terminal, comprising:
acquiring, at the data communications terminal, data from a data source via a network;
determining whether a printer connected to the data communications terminal is permitted to acquire the data from the data source and print the data; and
transmitting to the printer the data acquired by the data communications terminal, when it is determined that the printer is not permitted to acquire the data from the data source and print the data.

7. The printing method according to claim 6, wherein it is determined that the printer is not permitted to acquire the data from the data source or print the data, when the data source is a site that has an address that starts with https://.

8. The printing method according to claim 6, wherein it is determined that the printer is not permitted to acquire the data from the data source or print the data, when the Cookie is used to acquire the data from the data source.

9. The printing method according to claim 6, wherein it is determined that the printer is not permitted to acquire the data from the data source or print the data, when the printer is not connected to the network.
